(19) United States
(12) Patent Application Publication
(10) Pub. No.: US 2026/0302893 A1
(43) Pub. Date: Oct. 1, 2026

(54) HAPTIC MOTOR AND ELECTRONIC DEVICE

(71) Applicant: AAC Microtech (Changzhou) Co., Ltd., Changzhou City (CN)

(72) Inventors: Wei Song, Changzhou (CN); Lubin Mao, Changzhou (CN); Zhang Ren, Changzhou (CN)

(21) Appl. No.: 19/294,361

(22) Filed: Aug. 8, 2025

Related U.S. Application Data
(63) Continuation of application No. PCT/CN2025/084756, filed on Mar. 25, 2025.

(51) Int. Cl. H02K 11/215; H02K 33/18

(52) U.S. Cl. CPC H02K 11/215; H02K 33/18; H02K 2211/03

(57) ABSTRACT

A haptic motor and an electronic device are provided, relating to the field of key technologies. The haptic motor includes a hollow housing with an opening, stator assemblies fixed to opposite sides of the housing, a vibrator assembly elastically supported at both ends within the housing, and a key fixedly covers the vibrator assembly at the opening of the housing. The Hall sensor is fixed to the second pole core, for detecting a pressing action applied to the key. Compared to the prior art, the Hall sensor in the haptic motor is fixed to the stator assembly and integrated with the stator assembly, without occupying additional thickness, thereby achieving a thinner design. When the vibrator displaces, the Hall sensor can directly detect a change in the B value of the magnetic steel in the vibrator assembly, without the need to add an additional sensing magnetic steel.

### CROSS REFERENCE TO RELATED APPLICATIONS

The present application is a continuation of PCT Patent Application No. PCT/CN2025/084756, filed Mar. 25, 2025, which is incorporated by reference herein in its entirety.

### TECHNICAL FIELD

The present invention relates to the field of key technologies, and in particular, to a haptic motor and an electronic device.

### BACKGROUND

In modern electronic devices, haptic motors detect a position and pressing force of a key press, thereby enabling accurate detection and achieving precise control, so as to provide users with intuitive and precise haptic feedback. Haptic motors are widely used in electronic devices such as smartphones, tablet computers, and household appliances.

However, the haptic motor in the related art requires a Hall sensor to detect a press signal. The Hall sensor additionally occupies space of the haptic motor, thereby increasing the thickness of the haptic motor. Meanwhile, since different press operations result in different pressing states, the haptic motor in the related art cannot accurately determine whether the press operation is a light press, a hard press, or a sliding motion, making it difficult to meet requirements of modern electronic devices for high sensitivity in press signal detection and reduced thickness.

Therefore, it is necessary to provide a new haptic motor and an electronic device to solve the above-mentioned technical problem.

### SUMMARY

An objective of the present invention is to provide a haptic motor and an electronic device, which are intended to meet the requirements for high sensitivity in press signal detection and reduced thickness of the haptic motor.

A haptic motor is provided. The haptic motor includes: a housing that is hollow and has an opening; stator assemblies fixed to opposite sides of the housing; a vibrator assembly, both ends of which are elastically supported by opposite ends of the housing; and a key fixedly covers the vibrator assembly at the opening of the housing. The stator assemblies are configured to drive the vibrator assembly to move in a first direction. The stator assemblies are disposed on opposite sides of the vibrator assembly in a second direction and are spaced apart from the vibrator assembly. The second direction is perpendicular to the first direction. The vibrator assembly comprises a magnetic steel and first pole cores respectively stacked and fixed to opposite sides of the magnetic steel along the first direction, and the key is fixed to a side of one of the first pole cores that faces away from the magnetic steel. The stator assemblies comprise two second pole cores respectively fixed to opposite sides of the housing in the second direction, an iron core fixed to the second pole cores, and a coil wound around the iron core. The haptic motor further comprises a Hall sensor configured to detect a pressing action applied to the key, and the Hall sensor is fixed to the second pole cores.

As an improvement, the Hall sensor is disposed at a distance from an outer peripheral side of the coil.

As an improvement, the Hall sensor is spaced apart from the iron core, and the coil is spaced to surround the Hall sensor and the iron core.

As an improvement, the haptic motor comprises two Hall sensors, the two Hall sensors being respectively fixed to sides of the two second pole cores that face toward each other, and the two Hall sensors being disposed on opposite sides of the vibrator assembly along a third direction, wherein the third direction is perpendicular to both the first direction and the second direction.

As an improvement, the haptic motor further comprises two flexible circuit boards, one end of each of the two flexible circuit boards being fixed to the second pole core of the respective stator assembly and electrically connected to the Hall sensor and the coil, and the other end of each of the flexible circuit boards extending outside the housing.

As an improvement, each of the flexible circuit boards comprises a flexible circuit board body and a first extension portion extending from the flexible circuit board body in a direction away from the stator assembly, and the flexible circuit board body is fixed to the second pole core and spaced apart from the coil and is electrically connected to the Hall sensor and the coil.

As an improvement, each of the flexible circuit boards further comprises a second extension portion extending from the flexible circuit board body toward the stator assembly, and the coil and the iron core are fixed to the second extension portion.

As an improvement, the haptic motor further comprises two non-metallic elastic members respectively fixed to opposite ends of the housing, the non-metallic elastic members are configured to deform in the first direction, and the two non-metallic elastic members are fixedly connected to the vibrator assembly and elastically support the vibrator assembly within the housing.

As an improvement, the housing comprises two side housings disposed opposite to and spaced apart from each other in the second direction, and two connection housings respectively connecting opposite ends of the two side housings in the third direction, the second pole core and the coil are respectively fixed to sides of the side housings that face toward each other, and the non-metallic elastic members are fixed to the connection housings.

As an improvement, the haptic motor further comprises a connector, one end of the connector being fixedly connected to the non-metallic elastic member, and the other end of the connector being fixedly connected to the vibrator assembly.

As an improvement, the key comprises a key body and a pressing portion extending from the key body toward the magnetic steel, and the pressing portion extends to and abuts against the first pole cores.

In a second aspect, an electronic device is further provided according to the present invention. The electronic device includes a frame and a haptic motor as described in any of the foregoing embodiments fixed within the frame. A receiving recess recessed inward is provided on an outer side of the frame. A housing is fixed within the receiving recess. The key structure is partially received in the receiving recess and is fixed to the vibrator assembly.

Compared with the prior art, the Hall sensor in the haptic motor of the present invention is fixed to the stator assembly and is integrated with the stator assembly, thereby not additionally occupying thickness space and achieving reduced thickness. In addition, since the vibrator assembly is a magnetic steel, the Hall sensor can directly detect the change in the B value of the magnetic steel in the vibrator assembly when the vibrator is displaced, without requiring an additional magnetic steel. Two Hall sensors are fixed to two respective stator assemblies, and are opposite along a third direction, such that changes in the detected data of the Hall sensors can be used to more accurately determine a press operation.

### BRIEF DESCRIPTION OF THE DRAWINGS

In order to more clearly illustrate the technical solutions in the embodiments of the present invention, brief descriptions of the drawings to be used in the following description of the embodiments are provided below. It is obvious that the drawings described below are only some embodiments of the present invention. Other drawings may also be obtained by those skilled in the art without any creative effort, based on these drawings.

FIG. 1 is a perspective view of a haptic motor according to a first embodiment of the present invention;

FIG. 2 is an exploded perspective view of the haptic motor according to the first embodiment of the present invention;

FIG. 3 is another perspective view of the haptic motor according to the first embodiment of the present invention;

FIG. 4 is a sectional view taken along line A-A in FIG. 3;

FIG. 5 is a perspective view of a haptic motor according to a second embodiment of the present invention;

FIG. 6 is a sectional view taken along line B-B in FIG. 5;

FIG. 7 is a perspective view of a haptic motor according to a third embodiment of the present invention;

FIG. 8 is a sectional view taken along line C-C in FIG. 7; and

FIG. 9 is a perspective view of an electronic device according to a fourth embodiment of the present invention.

### In the drawings:

100, haptic motor; 1, housing; 11, side housing;

12, connecting housing; 2, vibrator assembly; 21, magnetic steel;

22, first pole core; 3, stator assembly; 31, second pole core;

32, iron core; 33, coil; 4, key;

41, key body; 42, pressing portion; 5, Hall sensor;

6, flexible circuit board; 61, flexible circuit board body;

62, first extension portion; 63, second extension portion;

7, non-metallic elastic member; 8, connector; 200, electronic device

201, frame; 202, receiving recess.

### DETAILED DESCRIPTION OF THE EMBODIMENTS

The technical solutions of the embodiments of the present invention will be clearly and fully described below with reference to the drawings of the embodiments. It should be understood that the described embodiments are merely part of the embodiments of the present invention, rather than all embodiments. Based on the embodiments of the present invention, all other embodiments that can be obtained by those skilled in the art without any creative effort shall fall within the scope of protection of the present invention.

### First Embodiment

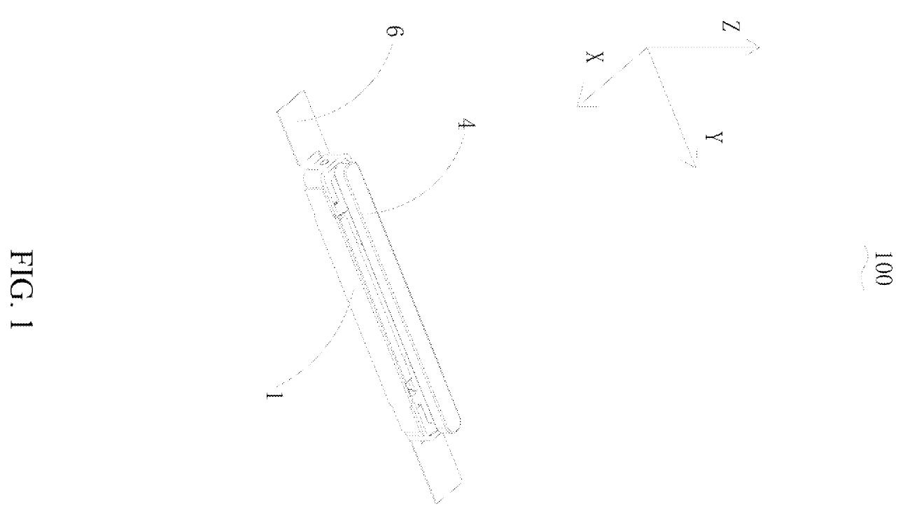

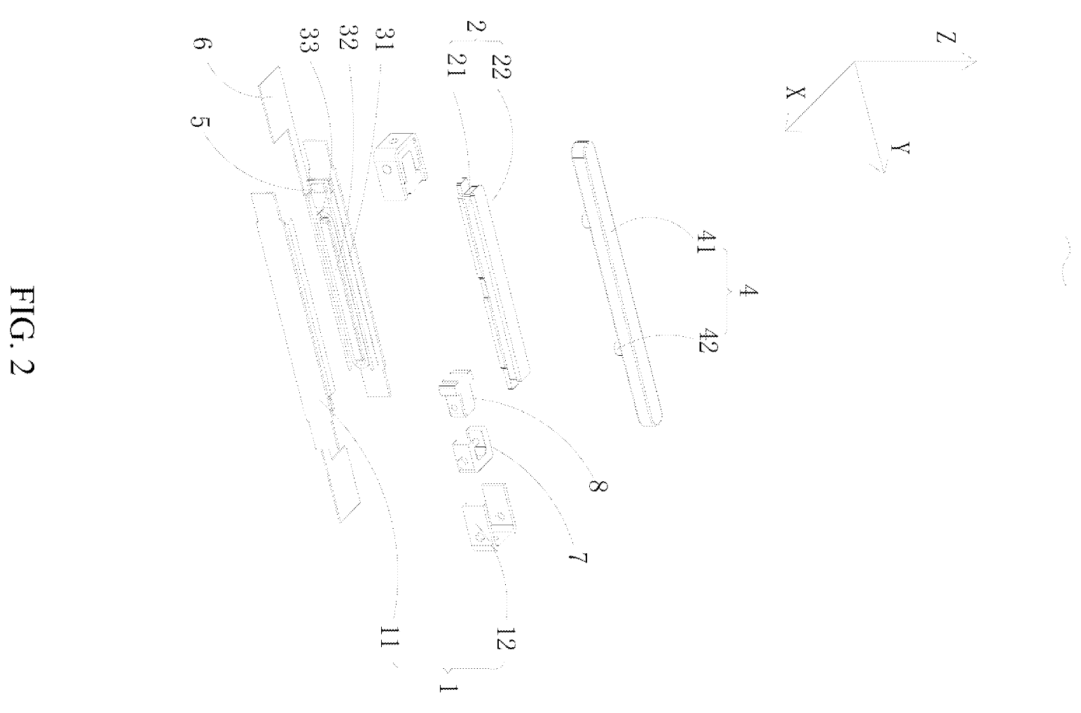

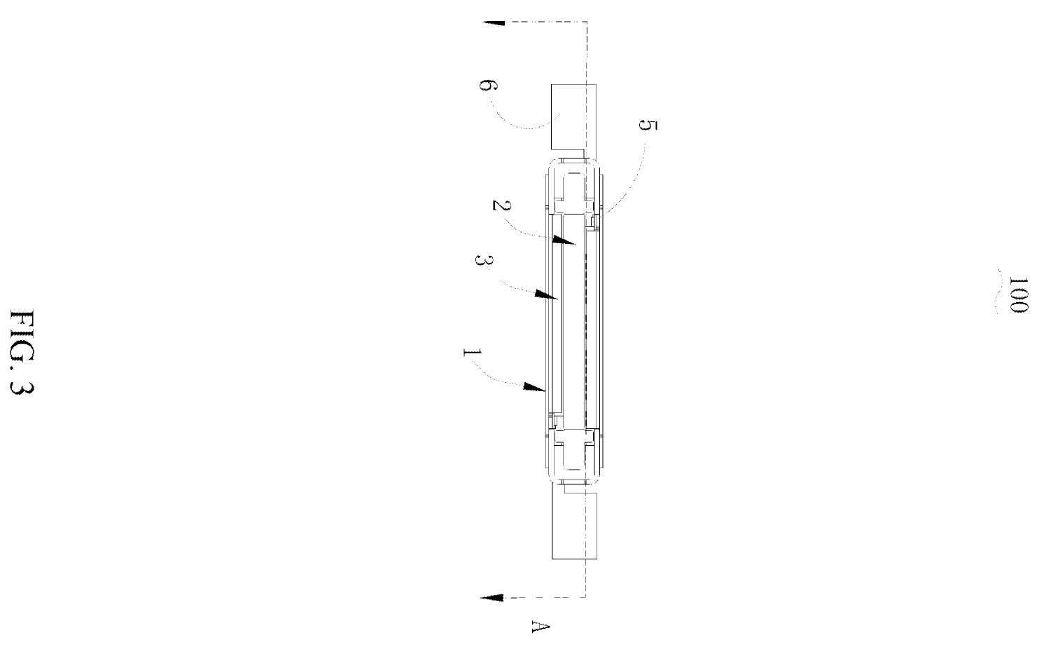

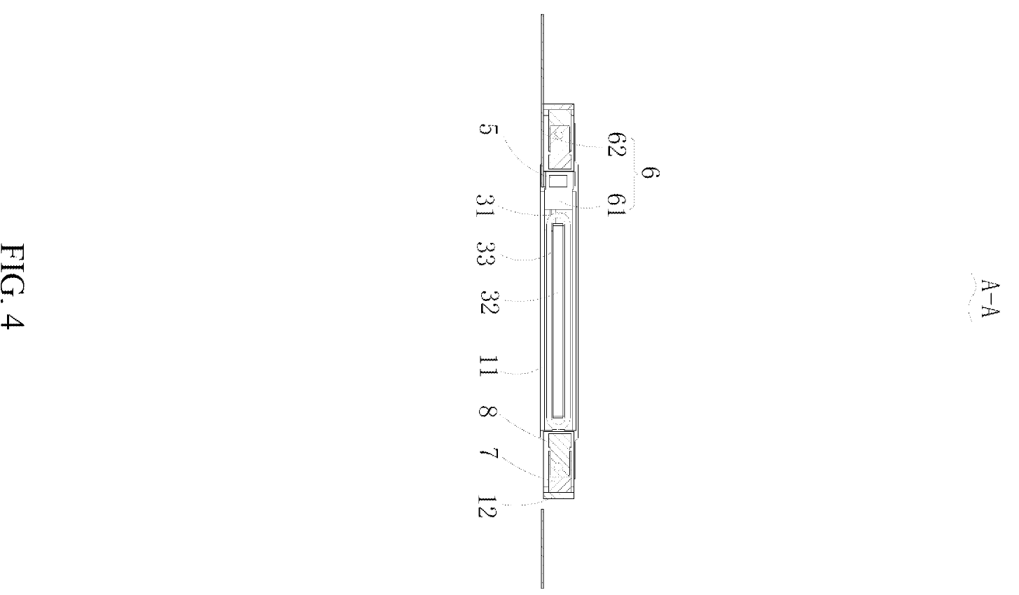

With reference to FIGS. 1 to 4, in the drawings, a Z-axis indicates a first direction, an X-axis indicates a second direction, and a Y-axis indicates a third direction. A haptic motor 100 is provided according to an embodiment of the present invention. The haptic motor 100 includes a housing 1 that is hollow and open-ended, stator assemblies 2 fixed to opposite sides of the housing 1, a vibrator assembly 3 that is elastically supported at opposite ends of the housing 1, and a key 4 mounted at the open end of the housing 1 and fixed to the vibrator assembly 3. The stator assemblies 2 are configured to drive the vibrator assembly 3 to move along the first direction. The stator assemblies 2 are disposed on opposite sides of the vibrator assembly 3 in the second direction and are spaced apart from the vibrator assembly 3. The second direction is perpendicular to the first direction. The vibrator assembly 3 includes a magnetic steel 21, and first pole cores 22 stacked on opposite sides of the magnetic steel 21 along the first direction. The key 4 is fixed to a side of one of the first pole cores 22, which faces away from the magnetic steel 21. The stator assemblies 2 include two second pole cores 31 respectively fixed to opposite sides of the housing 1 in the second direction, an iron core 32 fixed to the second pole core 31, and a coil 33 wound around the iron core 32.

The haptic motor 100 further includes a Hall sensor 5. The Hall sensor 5 is fixed to the second pole core 31 and is spaced apart from an outer peripheral side of the coil 33. The Hall sensor 5 is configured to detect a press operation applied to the key 4. The press operation includes, for example, a pressing force and a pressing position, such as a light press, a hard press, and a sliding motion.

Specifically, by fixing the Hall sensor 5 to the second pole core 31, the Hall sensor 5 is integrated with the stator assembly 2, thereby not additionally occupying thickness space.

In this embodiment, the housing 1 includes two side housings 11 that are spaced apart and opposite to each other along the second direction, and two connecting housings 12 that are respectively connected to opposite ends of the two side housings 11 along the third direction. The second pole core 31 and the coil 33 are fixed to sides of the side housings 11 that face toward each other.

In this embodiment, the key 4 includes a key body 41 and a pressing portion 42 that extends from the key body 41 toward the magnetic steel 21. The pressing portion 42 extends to and abuts against the first pole core 22, such that the vibrator assembly 3 is more stable, thereby improving the performance of the haptic motor 100. Two pressing portions 42 are oppositely disposed along the second direction, abutting against the first pole core 22. Therefore, when the key body 41 is pressed, the force transmitted from the pressing portions 42 to the first pole core 22 is more even.

In this embodiment, two Hall sensors 5 are respectively fixed to sides of the two second pole cores 31 that face toward each other. The two Hall sensors 5 are oppositely disposed on opposite sides of the vibrator assembly 2 along the third direction. The third direction is perpendicular to both the first direction and the second direction. Specifically, by disposing the two Hall sensors 5 at respective ends of the haptic motor 100, the vibrator assembly 3 is displaced along the third direction when a sliding operation occurs, and the data detected by the two Hall sensors 5 are different and change accordingly in real time. This satisfies requirements in different application scenarios and effectively improves the performance of the haptic motor 100.

In this embodiment, the haptic motor 100 further includes two flexible circuit boards 6. One end of each flexible circuit board 6 is fixed to the second pole core 31 of the respective stator assembly 2 and is electrically connected to the Hall sensor 5 and the coil 33. The other end of each flexible circuit board 6 extends outside the housing 1. Specifically, since the Hall sensor 5 and the coil 33 share the same flexible circuit board 6, the number of parts is reduced, which in turn lowers the cost of the haptic motor 100.

In this embodiment, the flexible circuit board 6 includes a flexible circuit board body 61 and a first extension portion 62 extending from the flexible circuit board body 61 in a direction away from the stator assembly 2. The flexible circuit board body 61 is fixed to the second pole core 31 and is spaced apart from the coil 33. The flexible circuit board body 61 is electrically connected to both the Hall sensor 5 and the coil 33. Specifically, since the flexible circuit board body 61 is spaced apart from the coil 33, there is no need to increase the width of the haptic motor 100, effectively expanding the application range of the haptic motor 100.

In this embodiment, the haptic motor 100 further includes two non-metallic elastic members 7, which are respectively fixed to opposite ends of the housing 1. The non-metallic elastic members 7 are capable of deforming along the first direction. Each of the two non-metallic elastic members 7 is also fixedly connected to the vibrator assembly 3, elastically supporting the vibrator assembly 3 within the housing 1. The non-metallic elastic members 7 are fixed in the connecting housings 12. As a result, the vibrator assembly 3 is more stable, thereby improving the performance of the haptic motor 100.

In this embodiment, the haptic motor 100 further includes a connector 8. One end of the connector 8 is fixedly connected to the non-metallic elastic member 7, and the other end of the connector 8 is fixedly connected to the vibrator assembly 3. As a result, the vibrator assembly 3 is more stable, thereby improving the performance of the haptic motor 100.

Compared with the prior art, the Hall sensor in the haptic motor of the present invention is fixed to the stator assembly and is integrated with the stator assembly, thereby not additionally occupying thickness space and achieving reduced thickness. In addition, since the vibrator assembly is a magnetic steel, the Hall sensor can directly detect the change in the B value of the magnetic steel in the vibrator assembly when the vibrator is displaced, without requiring an additional magnetic steel. Two Hall sensors are fixed to two respective stator assemblies, and are opposite along a third direction, such that changes in the detected data of the Hall sensors can be used to more accurately determine a press operation.

### Second Embodiment

The haptic motor in the second embodiment has a structure substantially the same as that of the haptic motor 100 in the first embodiment, with the difference being that: the flexible circuit board 6 further includes a second extension portion 63 extending from the flexible circuit board body 61 toward the stator assembly 2. The coil 33 and the iron core 32 are fixed to the second extension portion 63.

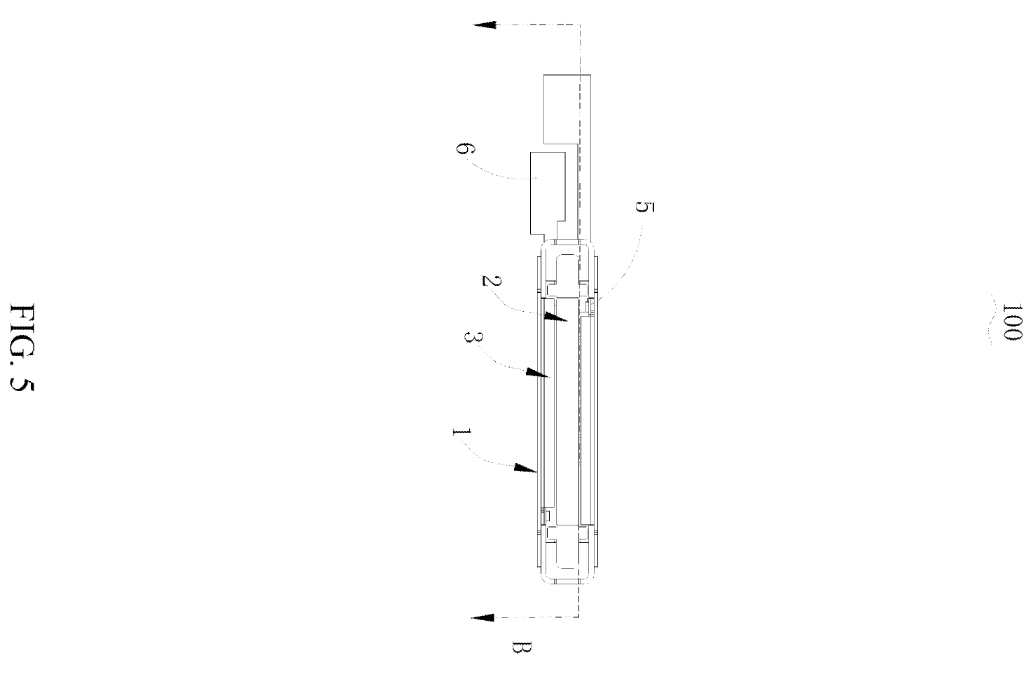

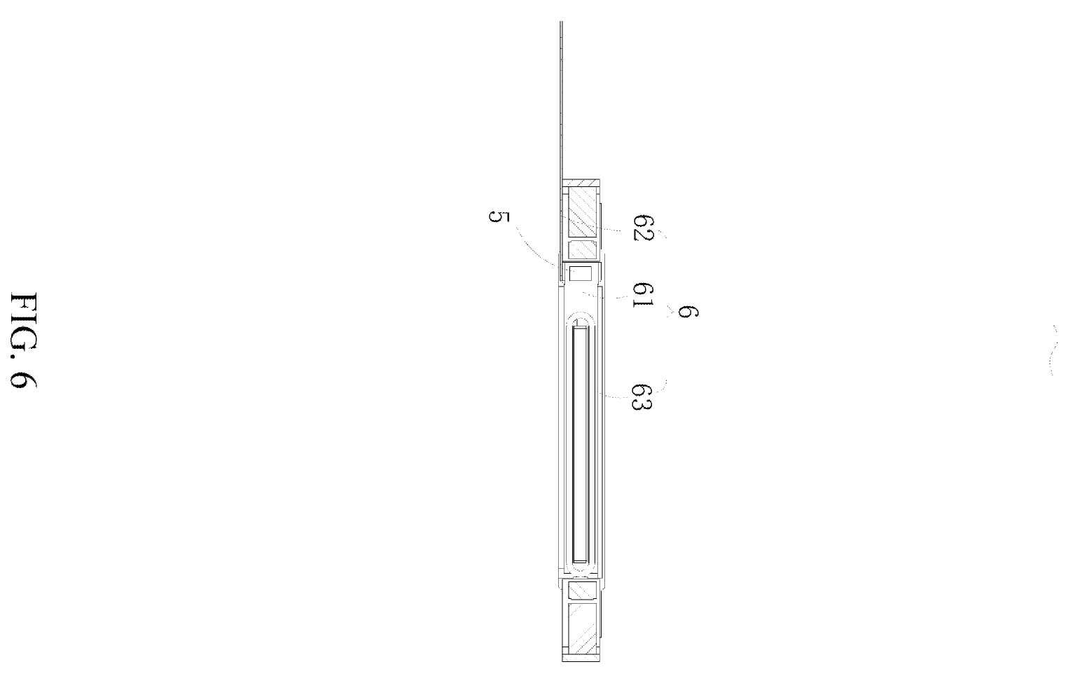

FIG. 5 is a perspective structural diagram of the haptic motor provided in the second embodiment of the present invention. FIG. 6 is a sectional view taken along line B-B in FIG. 5. The first extension portion 62 of the flexible circuit board 6 may extend from either the flexible circuit board body 61 or the second extension portion 63. As such, the two flexible circuit boards 6 may be led out from the same side of the haptic motor 100 as needed, thereby accommodating different application scenarios and expanding the application range of the haptic motor 100 without increasing its width.

### Third Embodiment

The haptic motor in the third embodiment has a structure substantially the same as that of the haptic motor 100 in the first embodiment, with the difference being that: the Hall sensor 5 is spaced apart from the iron core 32, and the coil 33 is disposed to surround both the Hall sensor 5 and the iron core 32 with a spacing therebetween.

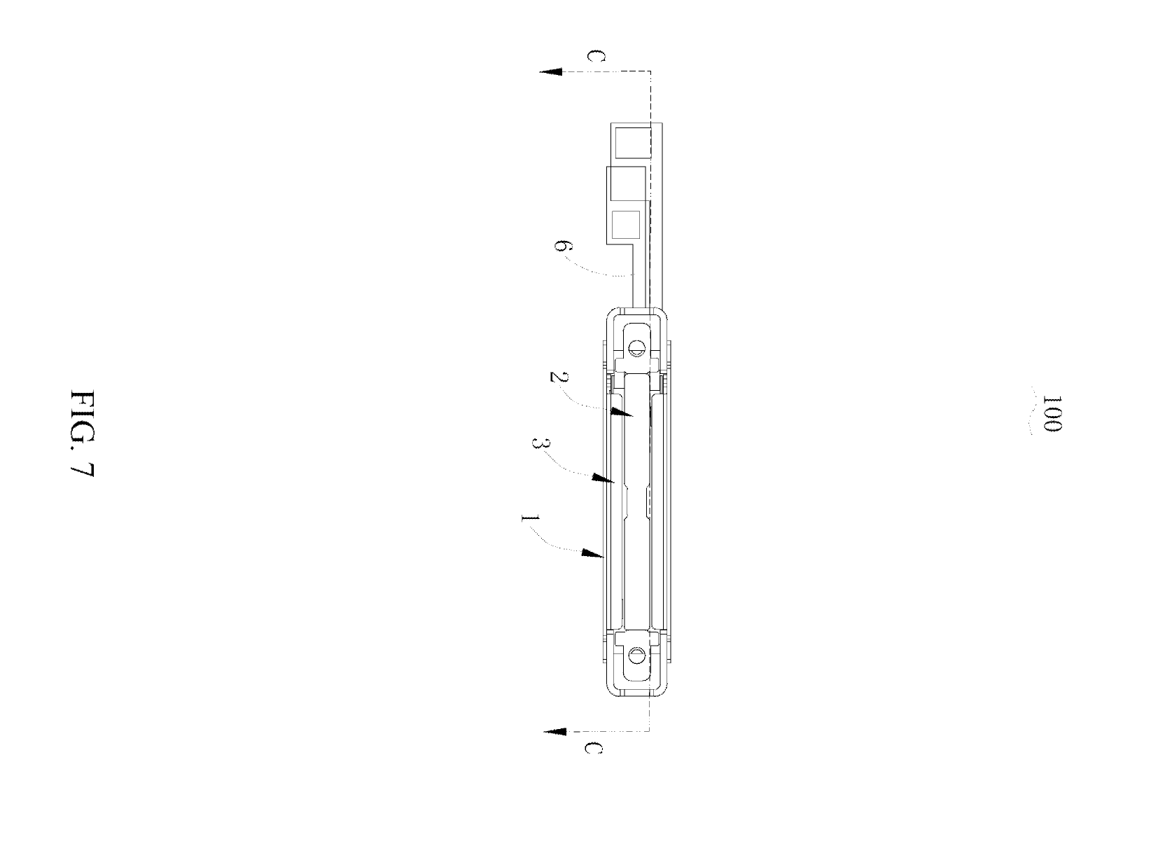

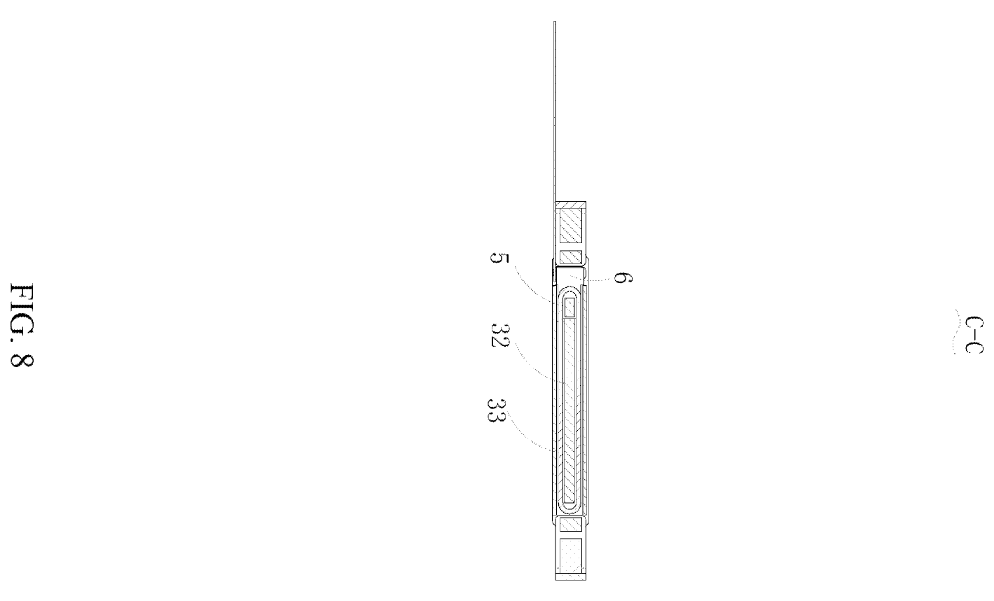

FIG. 7 is a perspective structural diagram of the haptic motor provided in the third embodiment of the present invention. FIG. 8 is a sectional view taken along line C-C in FIG. 7. Since the Hall sensor 5 and the iron core 32 are disposed within the coil 33, more space can be saved, thereby improving the performance of the haptic motor 100.

### Fourth Embodiment

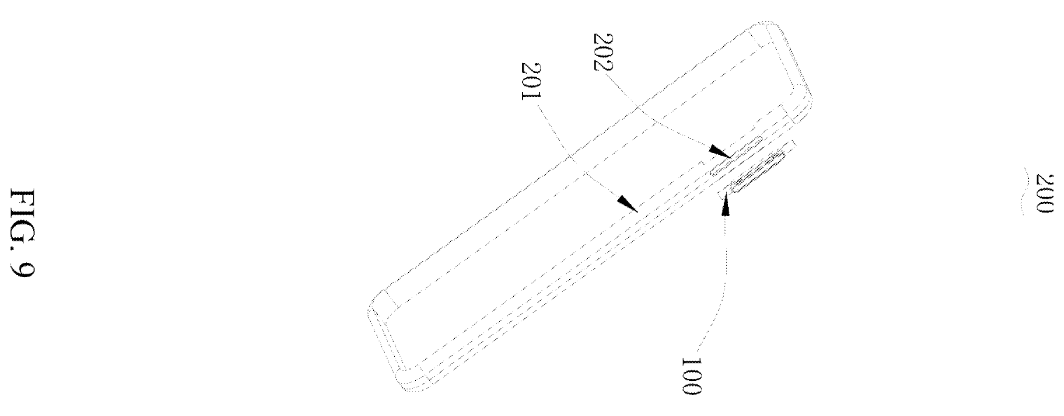

FIG. 9 is a perspective structural diagram of the electronic device provided in the fourth embodiment of the present invention. An electronic device 200 is provided according to the present invention. The electronic device 200 includes a frame 201 and a haptic motor 100, as described in any of the foregoing embodiments, fixed within the frame 201. An accommodating groove 202 recessed inward is provided on an outer side of the frame 201. The housing 1 is fixed within the accommodating groove 202. The key 4 is partially received in the accommodating groove 202 and is fixedly connected to the vibrator assembly 3. The electronic device 200 may be a device requiring key operation, such as a mobile phone, an AR device, earphones, a game controller, a steering wheel, or a tablet.

Since the electronic device 200 in the present embodiment includes the haptic motor 100 as described in the first embodiment, the electronic device 200 also achieves the same technical effects as the haptic motor 100 in the first embodiment, and details thereof are omitted herein for brevity.

Merely exemplary embodiments of the present invention are described above. It should be noted that a person of ordinary skill in the art may make modifications or improvements without departing from the inventive concept of the present invention, and all such modifications and improvements shall fall within the scope of protection of the present invention.

What is claimed is:

1. A haptic motor, comprising:
a housing that is hollow and has an opening;
stator assemblies fixed to opposite sides of the housing;
a vibrator assembly, both ends of which are elastically supported at opposite ends of the housing; and
a key fixedly covers the vibrator assembly at the opening of the housing,
wherein the stator assemblies are configured to drive the vibrator assembly to move in a first direction;
the stator assemblies are disposed on opposite sides of the vibrator assembly in a second direction and are spaced apart from the vibrator assembly;
the second direction is perpendicular to the first direction;
the vibrator assembly comprises a magnetic steel and first pole cores respectively stacked and fixed to opposite sides of the magnetic steel along the first direction, and the key is fixed to a side of one of the first pole cores that faces away from the magnetic steel;
the stator assemblies comprise two second pole cores respectively fixed to opposite sides of the housing in the second direction, an iron core fixed to the second pole cores, and a coil wound around the iron core;
wherein the haptic motor further comprises a Hall sensor configured to detect a pressing action applied to the key, and the Hall sensor is fixed to the second pole cores.

2. The haptic motor according to claim 1, wherein the Hall sensor is spaced apart from an outer peripheral side of the coil.

3. The haptic motor according to claim 1, wherein the Hall sensor is spaced apart from the iron core, and the coil is disposed surround both the Hall sensor and the iron core with a spacing.

4. The haptic motor according to claim 1, wherein the haptic motor comprises two Hall sensors, the two Hall sensors being respectively fixed to sides of the two second pole cores that face toward each other, and the two Hall sensors being disposed on opposite sides of the vibrator assembly along a third direction, wherein the third direction is perpendicular to both the first direction and the second direction.

5. The haptic motor according to claim 4, wherein the haptic motor further comprises two flexible circuit boards, one end of each of the two flexible circuit boards being fixed to the second pole core of the respective stator assembly and electrically connected to the Hall sensor and the coil, and the other end of each of the flexible circuit boards extending outside the housing.

6. The haptic motor according to claim 5, wherein each of the flexible circuit boards comprises a flexible circuit board body and a first extension portion extending from the flexible circuit board body in a direction away from the stator assembly, and the flexible circuit board body is fixed to the second pole core and spaced apart from the coil and is electrically connected to the Hall sensor and the coil.

7. The haptic motor according to claim 6, wherein each of the flexible circuit boards further comprises a second extension portion extending from the flexible circuit board body toward the stator assembly, and the coil and the iron core are fixed to the second extension portion.

8. The haptic motor according to claim 4, wherein the haptic motor further comprises two non-metallic elastic members respectively fixed to opposite ends of the housing, the non-metallic elastic members are configured to deform in the first direction, and the two non-metallic elastic members are fixedly connected to the vibrator assembly and elastically support the vibrator assembly within the housing.

9. The haptic motor according to claim 8, wherein the housing comprises two side housings disposed opposite to and spaced apart from each other in the second direction, and two connection housings respectively connecting opposite ends of the two side housings in the third direction, the second pole core and the coil are respectively fixed to sides of the side housings that face toward each other, and the non-metallic elastic members are fixed to the connection housings.

10. The haptic motor according to claim 8, wherein the haptic motor further comprises a connector, one end of the connector being fixedly connected to the non-metallic elastic member, and the other end of the connector being fixedly connected to the vibrator assembly.

11. The haptic motor according to claim 1, wherein the key comprises a key body and a pressing portion extending from the key body toward the magnetic steel, and the pressing portion extends to and abuts against the first pole cores.

12. An electronic device, comprising a frame and the haptic motor according to claim 1 fixed within the frame, wherein an accommodating groove recessed inward is defined on an outer side of the frame, the housing is fixed within the accommodating groove, and the key is partially accommodated in the accommodating groove and fixedly connected to the vibrator assembly.
